(19) United States
(12) Patent Application Publication
(10) Pub. No.: US 2024/0274853 A1
(43) Pub. Date: Aug. 15, 2024

(54) INTEGRATED ELECTROLYTE REBALANCING WITH FLOW BATTERY POWER MODULES

(71) Applicant: ESS TECH, INC., Wilsonville, OR (US)

(72) Inventors: Yang Song, Durham, NC (US); Gainer Phay, Wilsonville, OR (US)

(21) Appl. No.: 18/410,955

(22) Filed: Jan. 11, 2024

Related U.S. Application Data
(60) Provisional application No. 63/481,942, filed on Jan. 27, 2023.

(51) Int. Cl. H01M 8/18; H01M 8/04186; H01M 8/04276; H01M 8/0432; H01M 8/0444; H01M 8/04701; H01M 8/04746; H01M 8/04791; H01M 8/2455

(52) U.S. Cl. CPC H01M 8/188; H01M 8/04186; H01M 8/04276; H01M 8/0482; H01M 8/2455; H01M 8/0432; H01M 8/04477; H01M 8/04708; H01M 8/04753

(57) ABSTRACT

Systems and methods are provided for rebalancing electrolytes of a redox flow battery system. The redox flow battery system includes a positive electrolyte, a negative electrolyte, and a battery stack configured to receive the positive and negative electrolytes. Additionally, the battery stack includes an internal rebalancing reactor positioned internal to the battery stack and in fluid contact with the negative electrolyte.

### CROSS REFERENCE TO RELATED APPLICATIONS

The present application claims priority to U.S. Provisional Application No. 63/481,942 entitled INTEGRATED ELECTROLYTE REBALANCING WITH FLOW BATTERY POWER MODULES filed Jan. 27, 2023. The entire content of the above application is hereby incorporated by reference for all purposes.

### FIELD

The present description relates generally to systems and methods for rebalancing electrolytes of a redox flow battery.

### BACKGROUND AND SUMMARY

Redox flow batteries are suitable for grid-scale storage applications due to their capability for scaling power and capacity independently, as well as for charging and discharging over thousands of cycles with reduced performance losses in comparison to conventional battery technologies. An all-iron hybrid redox flow battery is particularly attractive due to incorporation of low-cost, earth-abundant materials. In general, iron redox flow batteries (IFBs) rely on iron, salt, and water for electrolyte, thus including simple, earth-abundant, and inexpensive materials, and eliminating incorporation of harsh chemicals and reducing an environmental footprint thereof.

The IFB may include a positive (redox) electrode where a redox reaction occurs and a negative (plating) electrode where ferrous iron (Fe²⁺) in the electrolyte may be reduced and plated. Various side reactions may compete with the Fe²⁺ reduction, including proton reduction, iron corrosion, and iron plating oxidation:

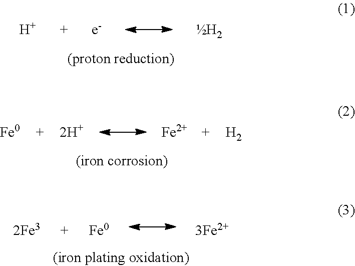

As most side reactions occur at the plating electrode, IFB cycling capabilities may be limited by available iron plating on the plating electrode. In addition to reducing an amount of plated Fe⁰, a presence of Fe³⁺ in a negative electrolyte may result in unwanted precipitation of iron hydroxides due to a higher pH of the negative electrolyte. Aside from diminishing a capacity of the redox flow battery, iron hydroxide precipitates may be undesirable due to their ability to clog fluid passages of the redox flow battery and coat a non-conductive layer on the plating electrode. Exemplary attempts to ameliorate iron plating loss have focused on catalytic electrolyte rebalancing to address hydrogen (H₂) gas generation from equations (1) and (2) and electrolyte charge imbalances (e.g., excess Fe³⁺) from equation (3) by ion crossover via equation (4):

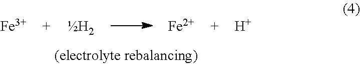

In some examples, negative electrolyte may be circulated to a rebalancing reactor positioned externally to a redox flow battery cell. The rebalancing reactor may be configured as an external jelly roll rebalancing reactor, wherein a catalyst is immobilized on a flat sheet of substrate and is spirally wound. The jelly roll may be positioned within a housing configured to receive electrolyte and hydrogen from the redox flow battery cell and direct the electrolyte and hydrogen through a center of the jelly roll to flow radially outwards.

However, inventors have recognized issues with the above external jelly roll rebalancing reactor. When electrolyte reaches the external jelly roll rebalancing reactor, the many small bubbles of hydrogen gas entrained within the electrolyte have coalesced into fewer large hydrogen gas bubbles. However, smaller hydrogen bubbles are desired because an increased available surface area of hydrogen increases a rate of the rebalancing reaction. Additionally, the electrolyte input to the center of the jelly roll may not effectively radiate outwards thereby limiting the useful catalyst of the jelly roll rebalancing reactor to the catalyst at or near the center of the jelly roll.

Previous attempts to address the above issues have included introduction of an injector and a booster pump at an inlet of the external jelly roll rebalancing reactor to break down the large hydrogen gas bubbles. However, operation of the injector and booster pump add to a parasitic power draw and cost of the redox flow battery system. Further, an amount of catalyst included in the external jelly roll rebalancing reactor may be increased to increase a rate of the rebalancing reaction. However, the catalyst is typically a precious metal such as platinum and increasing an amount of catalyst may increase an overall cost of the redox flow battery system.

In one example, the issues described above may be at least partially addressed by a redox flow battery system comprising: a positive electrolyte and a negative electrolyte, and a battery stack configured to receive the positive and negative electrolytes and including an internal rebalancing reactor positioned internal to the battery stack and in fluid contact with the negative electrolyte. In this way, electrolyte may be introduced to a rebalancing reactor before small hydrogen gas bubbles have time to coalesce and use of the injector and booster pump may be avoided. Additionally, negative electrolyte may be introduced to an outer surface of the jelly roll reactor and may be forced radially inward before exiting the redox flow battery stack, thereby increasing an amount of catalyst exposed to the electrolyte.

It should be understood that the summary above is provided to introduce in simplified form a selection of concepts that are further described in the detailed description. It is not meant to identify key or essential features of the claimed subject matter, the scope of which is defined uniquely by the claims that follow the detailed description. Furthermore, the claimed subject matter is not limited to implementations that solve any disadvantages noted above or in any part of this disclosure.

### BRIEF DESCRIPTION OF THE DRAWINGS

FIG. 1 shows a schematic diagram of an example redox flow battery system including a rebalancing reactor.

FIG. 2 shows a front view of an example layout for the redox flow battery system of FIG. 1.

FIG. 3 shows a perspective view of a battery stack of the redox flow battery system of FIG. 2.

FIG. 4 shows a side view of the battery stack of the redox flow battery system of FIG. 2.

FIG. 5A shows a view of an internal rebalancing reactor before winding.

FIG. 5B shows a view of the internal rebalancing reactor of FIG. 5A after winding.

FIG. 6A shows a front view of a portion of the battery stack of FIG. 3 including an internal rebalancing reactor.

FIG. 6B shows a rear view of a portion of the battery stack of FIG. 3 including the internal rebalancing reactor.

FIG. 7 shows an illustration of an internal cross section of the internal rebalancing reactor.

FIG. 8A shows a graph depicting voltaic efficiency of a battery stack with an external rebalancing reactor and with an internal rebalancing reactor.

FIG. 8B shows a graph depicting coulombic efficiency of the battery stack with the external rebalancing reactor and with the internal rebalancing reactor.

FIG. 8C shows a graph depicting energy efficiency of the battery stack with the external rebalancing reactor and with the internal rebalancing reactor.

FIG. 9 shows a flowchart of an example of a method for operating a redox flow battery system including an internal rebalancing reactor.

FIG. 10 shows the battery stack of FIG. 3 with an internal balancing reactor.

### DETAILED DESCRIPTION

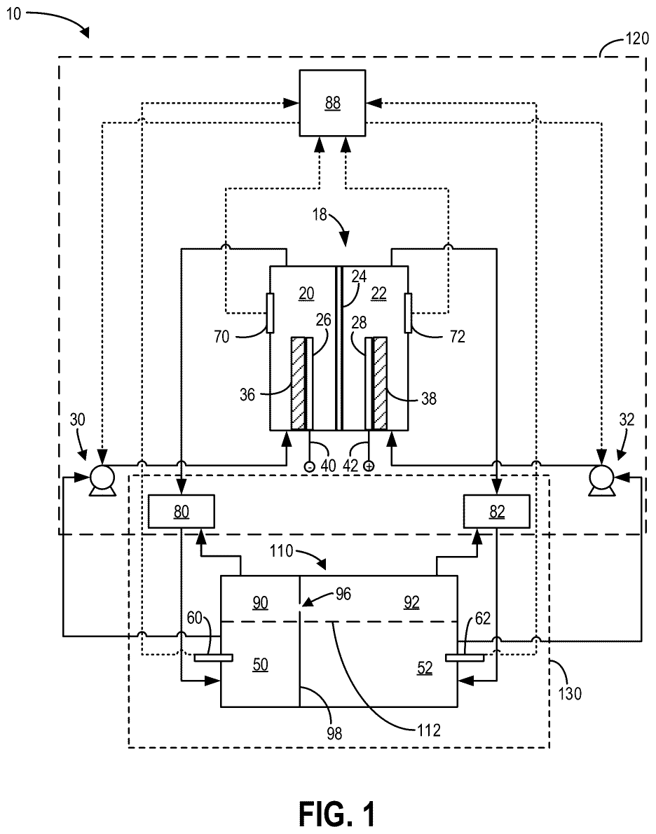

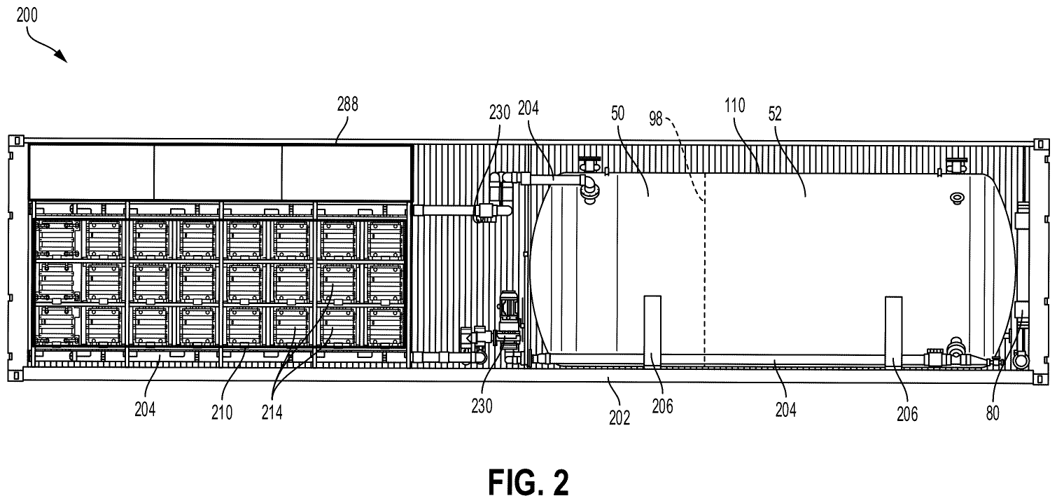

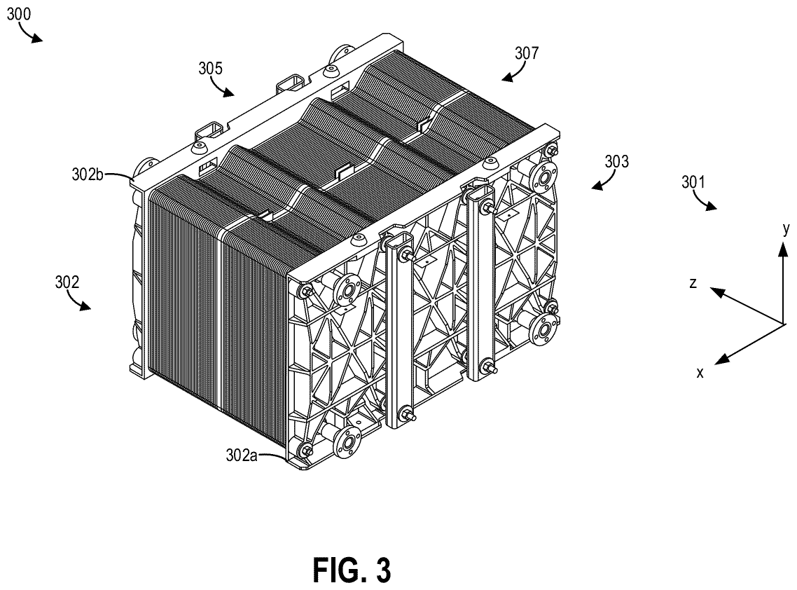

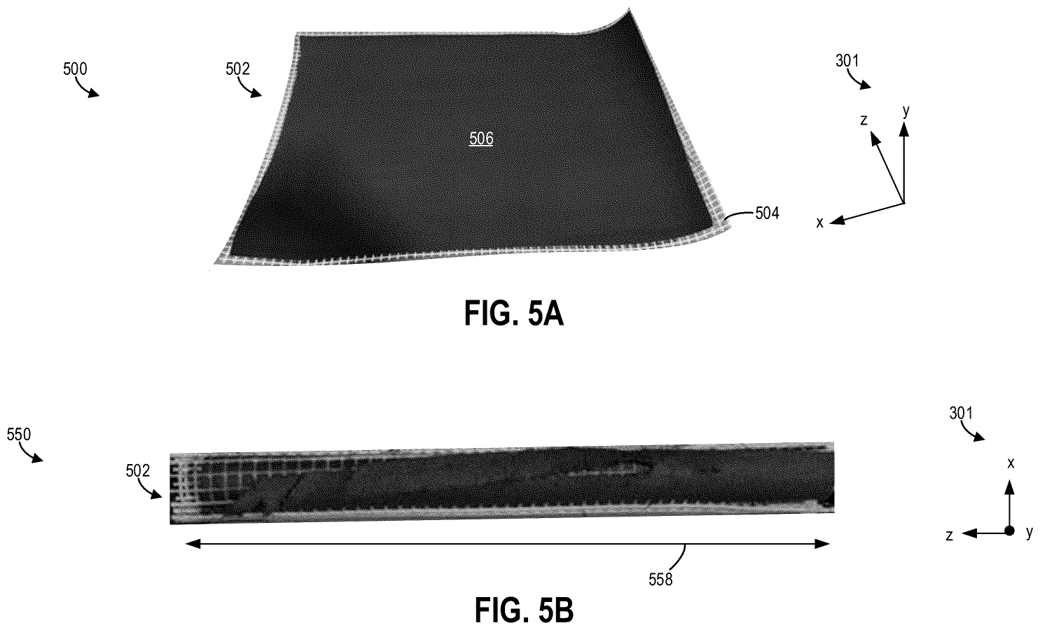

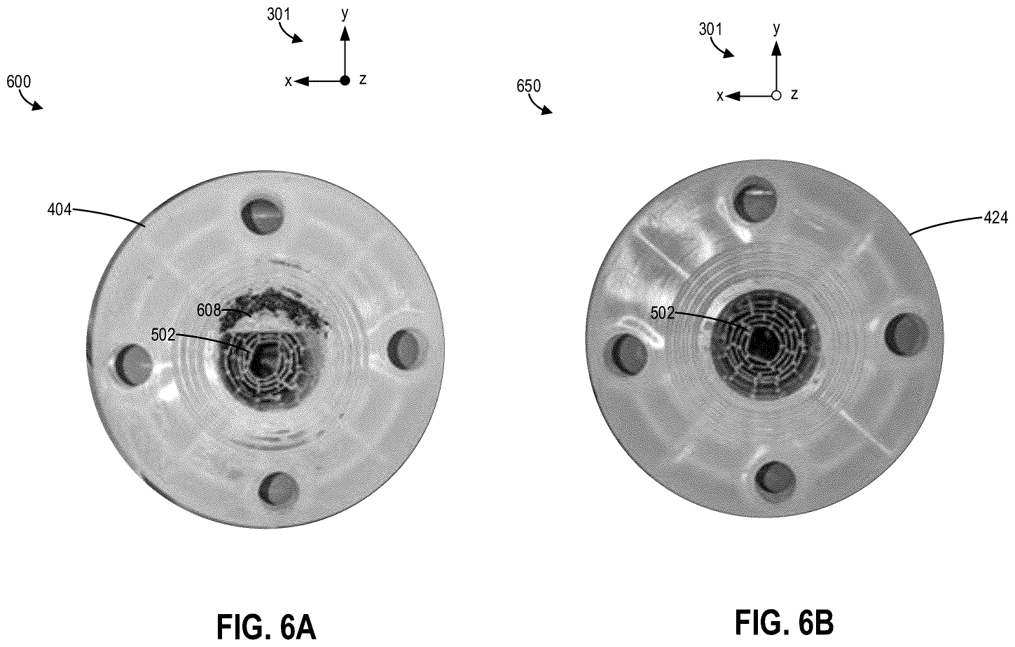

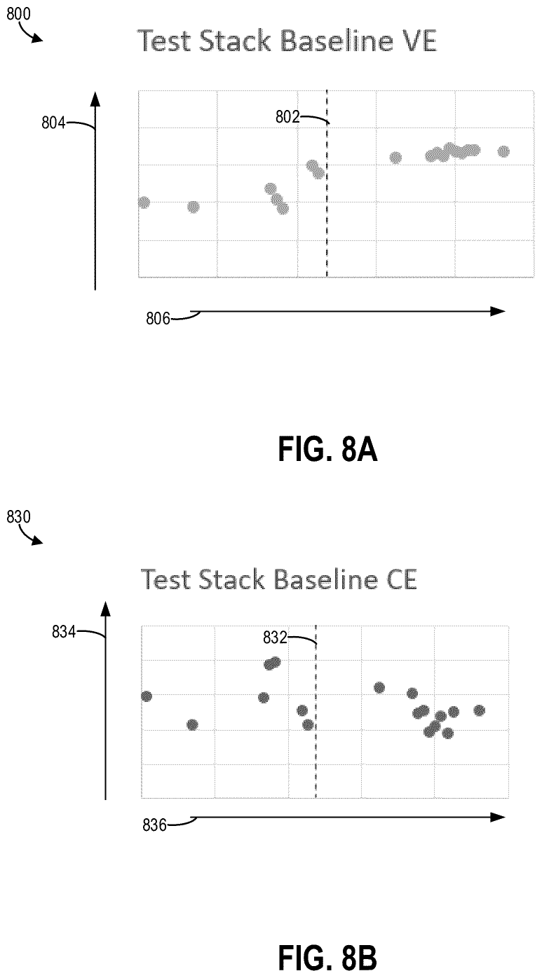

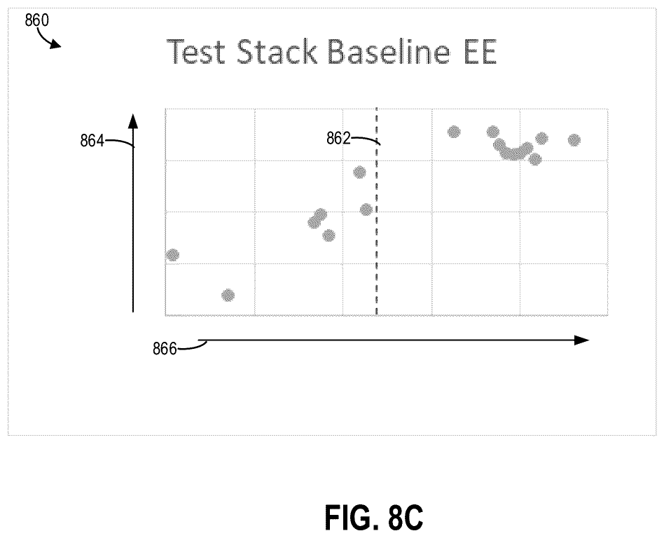

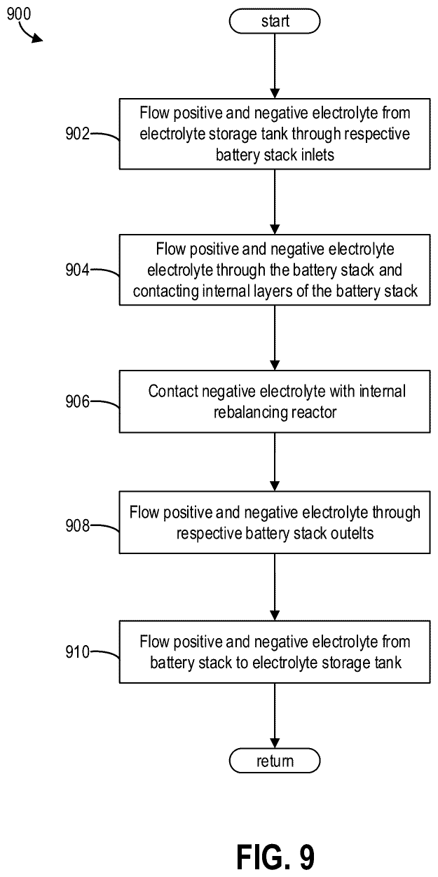

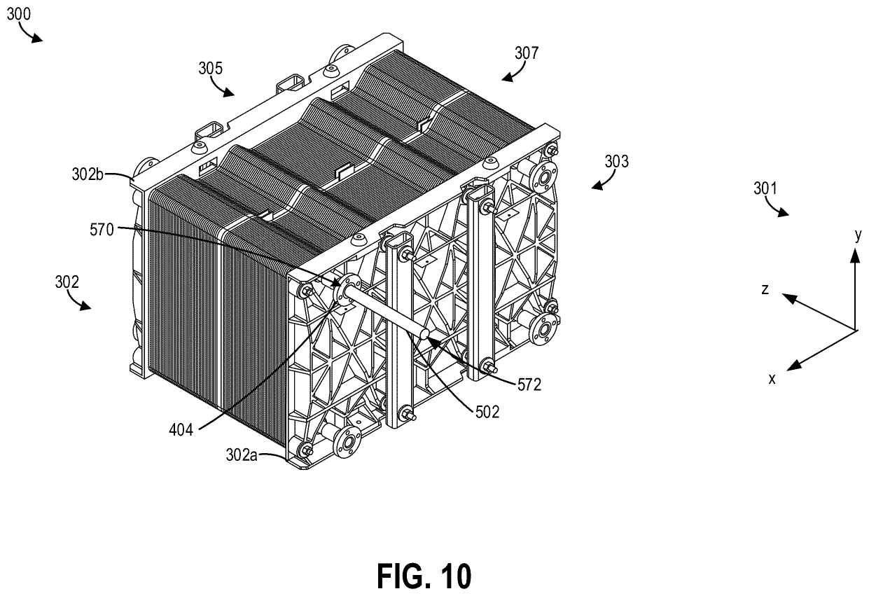

The following descriptions relates to systems and methods for an internal rebalancing reactor of a redox flow battery system. An example of a redox flow battery system including a redox flow battery cell and a rebalancing reactor is shown in FIG. 1. Electrolyte may be circulated from outlets of negative and positive electrode compartments of the redox flow battery cell to rebalancing reactors. Multiple redox flow battery cells may be included in a battery stack which is shown in a layout of a redox flow battery system in FIG. 2. The layout may include an example of a conventional external rebalancing reactor positioned away from the battery stack. There are issues with the external rebalancing reactor including the demand for a booster pump and injector to break up hydrogen bubbles which have coalesced by the time electrolyte reaches the external rebalancing reactor. The booster pump and the injector add to a parasitic power draw of the redox flow battery system. Instead, a battery stack, such as the battery stack shown in FIGS. 3, 4, and 10 may include an internal rebalancing reactor. An example of the internal rebalancing reactor is shown in FIGS. 5A-6B. Efficiencies of a redox flow battery system with an external rebalancing reactor and an internal rebalancing reactor may be compared as shown in the graphs of FIGS. 8A-C. An example of a method for operating a redox flow battery system using the internal rebalancing reactor described in FIGS. 5A-6B is shown as a flowchart in FIG. 9. An example of the internal rebalancing reactor positioned at least partially externally is shown in FIG. 10.

As shown in FIG. 1, in a redox flow battery system 10, a negative electrode 26 may be referred to as a plating electrode and a positive electrode 28 may be referred to as a redox electrode. A negative electrolyte within a plating side (e.g., a negative electrode compartment 20) of a redox flow battery cell 18 may be referred to as a plating electrolyte, and a positive electrolyte on a redox side (e.g., a positive electrode compartment 22) of the redox flow battery cell 18 may be referred to as a redox electrolyte.

“Anode” refers to an electrode where electroactive material loses electrons and “cathode” refers to an electrode where electroactive material gains electrons. During battery charge, the negative electrolyte gains electrons at the negative electrode 26, and the negative electrode 26 is the cathode of the electrochemical reaction. During battery discharge, the negative electrolyte loses electrons, and the negative electrode 26 is the anode of the electrochemical reaction. Alternatively, during battery discharge, the negative electrolyte and the negative electrode 26 may be respectively referred to as an anolyte and the anode of the electrochemical reaction, while the positive electrolyte and the positive electrode 28 may be respectively referred to as a catholyte and the cathode of the electrochemical reaction. During battery charge, the negative electrolyte and the negative electrode 26 may be respectively referred to as the catholyte and the cathode of the electrochemical reaction, while the positive electrolyte and the positive electrode 28 may be respectively referred to as the anolyte and the anode of the electrochemical reaction. For simplicity, the terms “positive” and “negative” are used herein to refer to the electrodes, electrolytes, and electrode compartments in redox flow battery systems.

One example of a hybrid redox flow battery is an all-iron redox flow battery (IFB), in which the electrolyte includes iron ions in the form of iron salts (e.g., FeCl₂, FeCl₃, and the like), wherein the negative electrode 26 includes metal iron. For example, at the negative electrode 26, ferrous iron (Fe²⁺) gains two electrons and plates as iron metal (Fe⁰) onto the negative electrode 26 during battery charge, and Fe²⁺ loses two electrons and re-dissolves as Fe²⁺ during battery discharge. At the positive electrode 28, Fe²⁺ loses an electron to form ferric iron (Fe³⁺) during battery charge, and Fe³⁺ gains an electron to form Fe²⁺ during battery discharge. The electrochemical reaction is summarized in equations (5) and (6), wherein the forward reactions (left to right) indicate electrochemical reactions during battery charge, while the reverse reactions (right to left) indicate electrochemical reactions during battery discharge:

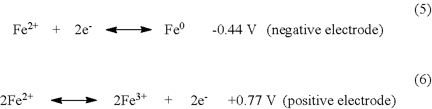

As discussed above, the negative electrolyte used in the IFB may provide a sufficient amount of Fe²⁺ so that, during battery charge, Fe²⁺ may accept two electrons from the negative electrode 26 to form Fe⁰ and plate onto a substrate. During battery discharge, the plated Fe⁰ may lose two electrons, ionizing into Fe²⁺ and dissolving back into the electrolyte. An equilibrium potential of the above reaction is −0.44 V, and this reaction therefore provides a negative terminal for the desired system. On the positive side of the IFB, the electrolyte may provide Fe²⁺ during battery charge which loses an electron and oxidizes to Fe³⁺. During battery discharge, Fe³⁺ provided by the electrolyte becomes Fe²⁺ by absorbing an electron provided by the positive electrode 28. An equilibrium potential of this reaction is +0.77 V, creating a positive terminal for the desired system.

The IFB may provide the ability to charge and recharge electrolytes therein in contrast to other battery types utilizing non-regenerating electrolytes. Charge may be achieved by respectively applying an electric current across the electrodes 26 and 28 via terminals 40 and 42. The negative electrode 26 may be electrically coupled via the terminal 40 to a negative side of a voltage source so that electrons may be delivered to the negative electrolyte via the positive electrode 28 (e.g., as Fe²⁺ is oxidized to Fe³⁺ in the positive electrolyte in the positive electrode compartment 22). The electrons provided to the negative electrode 26 may reduce the Fe²⁺ in the negative electrolyte to form Fe⁰ at the (plating) substrate, causing the Fe²⁺ to plate onto the negative electrode 26.

Discharge may be sustained while Fe⁰ remains available to the negative electrolyte for oxidation and while Fe³⁺ remains available in the positive electrolyte for reduction. As an example, Fe³⁺ availability may be maintained by increasing a concentration or a volume of the positive electrolyte in the positive electrode compartment 22 side of the redox flow battery cell 18 to provide additional Fe³⁺ ions via an external source, such as an external positive electrolyte chamber 52. More commonly, availability of Fe⁰ during discharge may be an issue in IFB systems, wherein the Fe⁰ available for discharge may be proportional to a surface area and a volume of the negative electrode substrate, as well as to a plating efficiency. Charge capacity may be dependent on the availability of Fe²⁺ in the negative electrode compartment 20. As an example, Fe²⁺ availability may be maintained by providing additional Fe²⁺ ions via an external source, such as an external negative electrolyte chamber 50 to increase a concentration or a volume of the negative electrolyte to the negative electrode compartment 20 side of the redox flow battery cell 18.

In an IFB, the positive electrolyte may include ferrous iron, ferric iron, ferric complexes, or any combination thereof, while the negative electrolyte may include ferrous iron or ferrous complexes, depending on a state of charge (SOC) of the IFB system. As previously mentioned, utilization of iron ions in both the negative electrolyte and the positive electrolyte may allow for utilization of the same electrolytic species on both sides of the redox flow battery cell 18, which may reduce electrolyte cross-contamination and may increase the efficiency of the IFB system, resulting in less electrolyte replacement as compared to other redox flow battery systems.

Efficiency losses in an IFB may result from electrolyte crossover through a separator 24 (e.g., ion-exchange membrane barrier, microporous membrane, and the like). For example, Fe³⁺ ions in the positive electrolyte may be driven toward the negative electrolyte by a Fe³⁺ ion concentration gradient and an electrophoretic force across the separator 24. Subsequently, Fe³⁺ ions penetrating the separator 24 and crossing over to the negative electrode compartment 20 may result in coulombic efficiency losses. Fe³⁺ ions crossing over from the low pH redox side (e.g., more acidic positive electrode compartment 22) to the high pH plating side (e.g., less acidic negative electrode compartment 20) may result in precipitation of Fe(OH)₃. Precipitation of Fe(OH)₃ may degrade the separator 24 and cause permanent battery performance and efficiency losses. For example, Fe(OH)₃ precipitate may chemically foul an organic functional group of an ion-exchange membrane or physically clog micropores of the ion-exchange membrane. In either case, due to the Fe(OH)₃ precipitate, membrane ohmic resistance may rise over time and battery performance may degrade. Precipitate may be removed by washing the IFB with acid, but constant maintenance and downtime may be disadvantageous for commercial battery applications. Furthermore, washing may be dependent on regular preparation of electrolyte, contributing to additional processing costs and complexity. Alternatively, adding specific organic acids to the positive electrolyte and the negative electrolyte in response to electrolyte pH changes may mitigate precipitate formation during battery charge and discharge cycling without driving up overall costs. Additionally, implementing a membrane barrier that inhibits Fe³⁺ ion crossover may also mitigate fouling.

Additional coulombic efficiency losses may be caused by reduction of H⁺ (e.g., protons) and subsequent formation of H₂ gas, and a reaction of protons in the negative electrode compartment 20 with electrons supplied at the plated iron metal of the negative electrode 26 to form H₂ gas.

The IFB electrolyte (e.g., FeCl₂, FeCl₃, FeSO₄, Fe₂(SO₄)₃, and the like) may be readily available and may be produced at low costs. In one example, the IFB electrolyte may be formed from ferrous chloride (FeCl₂), potassium chloride (KCl), manganese(II) chloride (MnCl₂), and boric acid (H₃BO₃). The IFB electrolyte may offer higher reclamation value because the same electrolyte may be used for the negative electrolyte and the positive electrolyte, consequently reducing cross-contamination issues as compared to other systems. Furthermore, because of iron's electron configuration, iron may solidify into a generally uniform solid structure during plating thereof on the negative electrode substrate. For zinc and other metals commonly used in hybrid redox batteries, solid dendritic structures may form during plating. A stable electrode morphology of the IFB system may increase the efficiency of the battery in comparison to other redox flow batteries. Further still, iron redox flow batteries may reduce the use of toxic raw materials and may operate at a relatively neutral pH as compared to other redox flow battery electrolytes. Accordingly, IFB systems may reduce environmental hazards as compared with all other current advanced redox flow battery systems in production.

Continuing with FIG. 1, a schematic illustration of the redox flow battery system 10 is shown. The redox flow battery system 10 may include the redox flow battery cell 18 fluidly coupled to an integrated multi-chambered electrolyte storage tank 110. The redox flow battery cell 18 may include the negative electrode compartment 20, separator 24, and positive electrode compartment 22. The separator 24 may include an electrically insulating ionic conducting barrier which prevents bulk mixing of the positive electrolyte and the negative electrolyte, while allowing conductance of specific ions therethrough. For example, and as discussed above, the separator 24 may include an ion-exchange membrane and/or a microporous membrane.

The negative electrode compartment 20 may include the negative electrode 26, and the negative electrolyte may include electroactive materials. The positive electrode compartment 22 may include the positive electrode 28, and the positive electrolyte may include electroactive materials. In some examples, multiple redox flow battery cells 18 may be combined in series or in parallel to generate a higher voltage or electric current in the redox flow battery system 10.

Further illustrated in FIG. 1 are negative and positive electrolyte pumps 30 and 32, both used to pump electrolyte solution through the redox flow battery system 10. Electrolytes are stored in one or more tanks external to the cell, and are pumped via the negative and positive electrolyte pumps 30 and 32 through the negative electrode compartment 20 side and the positive electrode compartment 22 side of the redox flow battery cell 18, respectively.

The redox flow battery system 10 may also include a first bipolar plate 36 and a second bipolar plate 38, each positioned along a rear-facing side, e.g., opposite of a side facing the separator 24, of the negative electrode 26 and the positive electrode 28, respectively. The first bipolar plate 36 may be in contact with the negative electrode 26 and the second bipolar plate 38 may be in contact with the positive electrode 28. In other examples, however, the bipolar plates 36 and 38 may be arranged proximate but spaced away from the electrodes 26 and 28 and housed within the respective electrode compartments 20 and 22. In either case, the bipolar plates 36 and 38 may be electrically coupled to the terminals 40 and 42, respectively, either via direct contact therewith or through the negative and positive electrodes 26 and 28, respectively. The IFB electrolytes may be transported to reaction sites at the negative and positive electrodes 26 and 28 by the first and second bipolar plates 36 and 38, resulting from conductive properties of a material of the bipolar plates 36 and 38. Electrolyte flow may also be assisted by the negative and positive electrolyte pumps 30 and 32, facilitating forced convection through the redox flow battery cell 18. Reacted electrochemical species may also be directed away from the reaction sites by a combination of forced convection and a presence of the first and second bipolar plates 36 and 38.

As illustrated in FIG. 1, the redox flow battery cell 18 may further include the negative battery terminal 40 and the positive battery terminal 42. When a charge current is applied to the battery terminals 40 and 42, the positive electrolyte may be oxidized (loses one or more electrons) at the positive electrode 28, and the negative electrolyte may be reduced (gains one or more electrons) at the negative electrode 26. During battery discharge, reverse redox reactions may occur on the electrodes 26 and 28. In other words, the positive electrolyte may be reduced (gains one or more electrons) at the positive electrode 28, and the negative electrolyte may be oxidized (loses one or more electrons) at the negative electrode 26. An electrical potential difference across the battery may be maintained by the electrochemical redox reactions in the positive electrode compartment 22 and the negative electrode compartment 20, and may induce an electric current through a current collector while the reactions are sustained. An amount of energy stored by a redox battery may be limited by an amount of electroactive material available in electrolytes for discharge, depending on a total volume of electrolytes and a solubility of the electroactive materials.

The redox flow battery system 10 may further include the integrated multi-chambered electrolyte storage tank 110. The multi-chambered electrolyte storage tank 110 may be divided by a bulkhead 98. The bulkhead 98 may create multiple chambers within the multi-chambered electrolyte storage tank 110 so that both the positive and negative electrolytes may be included within a single tank. The negative electrolyte chamber 50 holds negative electrolyte including the electroactive materials, and the positive electrolyte chamber 52 holds positive electrolyte including the electroactive materials. The bulkhead 98 may be positioned within the multi-chambered electrolyte storage tank 110 to yield a desired volume ratio between the negative electrolyte chamber 50 and the positive electrolyte chamber 52. In one example, the bulkhead 98 may be positioned to set a volume ratio of the negative and positive electrolyte chambers 50 and 52 according to a stoichiometric ratio between the negative and positive redox reactions. FIG. 1 further illustrates a fill height 112 of the multi-chambered electrolyte storage tank 110, which may indicate a liquid level in each tank compartment. FIG. 1 also shows a gas head space 90 located above the fill height 112 of the negative electrolyte chamber 50, and a gas head space 92 located above the fill height 112 of the positive electrolyte chamber 52. The gas head space 92 may be utilized to store H₂ gas generated through operation of the redox flow battery (e.g., due to proton reduction and iron corrosion side reactions) and conveyed to the multi-chambered electrolyte storage tank 110 with returning electrolyte from the redox flow battery cell 18. The H₂ gas may be separated spontaneously at a gas-liquid interface (e.g., the fill height 112) within the multi-chambered electrolyte storage tank 110, thereby precluding having additional gas-liquid separators as part of the redox flow battery system 10. Once separated from the electrolyte, the H₂ gas may fill the gas head spaces 90 and 92. As such, the stored H₂ gas may aid in purging other gases from the multi-chambered electrolyte storage tank 110, thereby acting as an inert gas blanket for reducing oxidation of electrolyte species, which may help to reduce redox flow battery capacity losses. In this way, utilizing the integrated multi-chambered electrolyte storage tank 110 may forego having separate negative and positive electrolyte storage tanks, hydrogen storage tanks, and gas-liquid separators common to conventional redox flow battery systems, thereby simplifying a system design, reducing a physical footprint of the redox flow battery system 10, and reducing system costs.

FIG. 1 also shows a spillover hole 96, which may create an opening in the bulkhead 98 between the gas head spaces 90 and 92, and may provide a means of equalizing gas pressure between the chambers 50 and 52. The spillover hole 96 may be positioned at a threshold height above the fill height 112. The spillover hole 96 may further enable a capability to self-balance the electrolytes in each of the negative and positive electrolyte chambers 50 and 52 in the event of a battery crossover. In the case of an all-iron redox flow battery system, the same electrolyte (Fe²⁺) is used in both negative and positive electrode compartments 20 and 22, so spilling over of electrolyte between the negative and positive electrolyte chambers 50 and 52 may reduce overall system efficiency, but overall electrolyte composition, battery module performance, and battery module capacity may be maintained. Flange fittings may be utilized for all piping connections for inlets and outlets to and from the multi-chambered electrolyte storage tank 110 to maintain a continuously pressurized state without leaks. The multi-chambered electrolyte storage tank 110 may include at least one outlet from each of the negative and positive electrolyte chambers 50 and 52, and at least one inlet to each of the negative and positive electrolyte chambers 50 and 52. Furthermore, one or more outlet connections may be provided from the gas head spaces 90 and 92 for directing H₂ gas to rebalancing reactors 80 and 82.

Although not shown in FIG. 1, the integrated multi-chambered electrolyte storage tank 110 may further include one or more heaters thermally coupled to each of the negative electrolyte chamber 50 and the positive electrolyte chamber 52. In alternate examples, only one of the negative and positive electrolyte chambers 50 and 52 may include one or more heaters. In the case where only the positive electrolyte chamber 52 includes one or more heaters, the negative electrolyte may be heated by transferring heat generated at the redox flow battery cell 18 to the negative electrolyte. In this way, the redox flow battery cell 18 may heat and facilitate temperature regulation of the negative electrolyte. The one or more heaters may be actuated by a controller 88 to regulate a temperature of the negative electrolyte chamber 50 and the positive electrolyte chamber 52 independently or together. For example, in response to an electrolyte temperature decreasing below a threshold temperature, the controller 88 may increase a power supplied to one or more heaters so that a heat flux to the electrolyte may be increased. The electrolyte temperature may be indicated by one or more temperature sensors mounted at the multi-chambered electrolyte storage tank 110, such as sensors 60 and 62. As examples, the one or more heaters may include coil type heaters or other immersion heaters immersed in the electrolyte fluid, or surface mantle type heaters that transfer heat conductively through the walls of the negative and positive electrolyte chambers 50 and 52 to heat the fluid therein. Other known types of tank heaters may be employed without departing from the scope of the present disclosure. Furthermore, the controller 88 may deactivate the one or more heaters in the negative and positive electrolyte chambers 50 and 52 in response to a liquid level decreasing below a solids fill threshold level. Said in another way, in some examples, the controller 88 may activate the one or more heaters in the negative and positive electrolyte chambers 50 and 52 only in response to a liquid level increasing above the solids fill threshold level. In this way, activating the one or more heaters without sufficient liquid in the negative and/or positive electrolyte chambers 50, 52 may be averted, thereby reducing a risk of overheating or burning out the heater(s).

Further still, one or more inlet connections may be provided to each of the negative and positive electrolyte chambers 50 and 52 from a field hydration system (not shown). In this way, the field hydration system may facilitate commissioning of the redox flow battery system 10, including installing, filling, and hydrating the redox flow battery system 10, at an end-use location. Furthermore, prior to commissioning the redox flow battery system 10 at the end-use location, the redox flow battery system 10 may be dry-assembled at a battery manufacturing facility different from the end-use location without filling and hydrating the redox flow battery system 10, before delivering the redox flow battery system 10 to the end-use location. In one example, the end-use location may correspond to a location where the redox flow battery system 10 is to be installed and utilized for on-site energy storage. Said another way, the redox flow battery system 10 may be designed such that, once installed and hydrated at the end-use location, a position of the redox flow battery system 10 may become fixed, and the redox flow battery system 10 may no longer be deemed a portable, dry system. Thus, from a perspective of an end-user, the dry, portable redox flow battery system 10 may be delivered on-site, after which the redox flow battery system 10 may be installed, hydrated, and commissioned. Prior to hydration, the redox flow battery system 10 may be referred to as a dry, portable system, the redox flow battery system 10 being free of or without water and wet electrolyte. Once hydrated, the redox flow battery system 10 may be referred to as a wet, non-portable system, the redox flow battery system 10 including wet electrolyte.

Further illustrated in FIG. 1, electrolyte solutions primarily stored in the multi-chambered electrolyte storage tank 110 may be pumped via the negative and positive electrolyte pumps 30 and 32 throughout the redox flow battery system 10. Electrolyte stored in the negative electrolyte chamber 50 may be pumped via the negative electrolyte pump 30 through the negative electrode compartment 20 side of the redox flow battery cell 18, and electrolyte stored in the positive electrolyte chamber 52 may be pumped via the positive electrolyte pump 32 through the positive electrode compartment 22 side of the redox flow battery cell 18.

The electrolyte rebalancing reactors 80 and 82 may be connected in line or in parallel with the recirculating flow paths of the electrolyte at the negative and positive sides of the redox flow battery cell 18, respectively, in the redox flow battery system 10. One or more rebalancing reactors may be connected in-line with the recirculating flow paths of the electrolyte at the negative and positive sides of the battery, and other rebalancing reactors may be connected in parallel, for redundancy (e.g., a rebalancing reactor may be serviced without disrupting battery and rebalancing operations) and for increased rebalancing capacity. In one example, the electrolyte rebalancing reactors 80 and 82 may be placed in a return flow path from the negative and positive electrode compartments 20 and 22 to the negative and positive electrolyte chambers 50 and 52, respectively.

The electrolyte rebalancing reactors 80 and 82 may serve to rebalance electrolyte charge imbalances in the redox flow battery system 10 occurring due to side reactions, ion crossover, and the like, as described herein. In one example, electrolyte rebalancing reactors 80 and 82 may include trickle bed reactors, where the H₂ gas and electrolyte may be contacted at catalyst surfaces in a packed bed for carrying out the electrolyte rebalancing reaction. In other examples, the rebalancing reactors 80 and 82 may include flow-through type reactors that are capable of contacting the H₂ gas and the electrolyte liquid and carrying out the electrolyte rebalancing reactions absent a packed catalyst bed. In the above examples, rebalancing reactors may be spaced away from and fluidly coupled to redox flow battery cell 18. However, in further examples, rebalancing reactors 80 and/or 82 may be formed as a rolled catalyst bed (e.g., a jelly roll) positioned internally to a battery stack comprising a plurality of redox flow battery cell 18. In one example, rebalancing reactor 80 may be positioned internal to the battery stack and may receive both electrolyte and hydrogen gas from negative electrode compartment 20. In a further example where rebalancing reactor 82 is positioned internal to the battery stack, rebalancing reactor 82 may receive electrolyte from positive electrode compartment 22 but may not receive hydrogen gas from positive electrode compartment 22. For this reason, injection of hydrogen gas from an external source into rebalancing reactor 82 positioned internal to the battery stack may be demanded. The internal rebalancing reactor may be described further below with respect to FIGS. 5-7.

During operation of the redox flow battery system 10, sensors and probes may monitor and control chemical properties of the electrolyte such as electrolyte pH, concentration, SOC, and the like. For example, as illustrated in FIG. 1, sensors 62 and 60 maybe be positioned to monitor positive electrolyte and negative electrolyte conditions at the positive electrolyte chamber 52 and the negative electrolyte chamber 50, respectively. In another example, sensors 62 and 60 may each include one or more electrolyte level sensors to indicate a level of electrolyte in the positive electrolyte chamber 52 and the negative electrolyte chamber 50, respectively. As another example, sensors 72 and 70, also illustrated in FIG. 1, may monitor positive electrolyte and negative electrolyte conditions at the positive electrode compartment 22 and the negative electrode compartment 20, respectively. The sensors 72 and 70 may be pH probes, optical probes, pressure sensors, voltage sensors, etc. It will be appreciated that sensors may be positioned at other locations throughout the redox flow battery system 10 to monitor electrolyte chemical properties and other properties.

For example, a sensor may be positioned in an external acid tank (not shown) to monitor acid volume or pH of the external acid tank, wherein acid from the external acid tank may be supplied via an external pump (not shown) to the redox flow battery system 10 in order to reduce precipitate formation in the electrolytes. Additional external tanks and sensors may be installed for supplying other additives to the redox flow battery system 10. For example, various sensors including, temperature, conductivity, and level sensors of a field hydration system may transmit signals to the controller 88. Furthermore, the controller 88 may send signals to actuators such as valves and pumps of the field hydration system during hydration of the redox flow battery system 10. Sensor information may be transmitted to the controller 88 which may in turn actuate the pumps 30 and 32 to control electrolyte flow through the redox flow battery cell 18, or to perform other control functions, as an example. In this manner, the controller 88 may be responsive to one or a combination of sensors and probes.

The redox flow battery system 10 may further include a source of H₂ gas. In one example, the source of H₂ gas may include a separate dedicated hydrogen gas storage tank. In the example of FIG. 1, H₂ gas may be stored in and supplied from the integrated multi-chambered electrolyte storage tank 110. The integrated multi-chambered electrolyte storage tank 110 may supply additional H₂ gas to the positive electrolyte chamber 52 and the negative electrolyte chamber 50. The integrated multi-chambered electrolyte storage tank 110 may alternately supply additional H₂ gas to an inlet of the electrolyte rebalancing reactors 80 and 82. As an example, a mass flow meter or other flow controlling device (which may be controlled by the controller 88) may regulate flow of the H₂ gas from the integrated multi-chambered electrolyte storage tank 110. The integrated multi-chambered electrolyte storage tank 110 may supplement the H₂ gas generated in the redox flow battery system 10. For example, when gas leaks are detected in the redox flow battery system 10 or when a reduction reaction rate is too low at low hydrogen partial pressure, the H₂ gas may be supplied from the integrated multi-chambered electrolyte storage tank 110 in order to rebalance the SOC of the electroactive materials in the positive electrolyte and the negative electrolyte. As an example, the controller 88 may supply the H₂ gas from the integrated multi-chambered electrolyte storage tank 110 in response to a measured change in pH or in response to a measured change in SOC of an electrolyte or an electroactive material.

For example, an increase in pH of the negative electrolyte chamber 50, or the negative electrode compartment 20, may indicate that H₂ gas is leaking from the redox flow battery system 10 and/or that the reaction rate is too slow with the available hydrogen partial pressure, and the controller 88, in response to the pH increase, may increase a supply of H₂ gas from the integrated multi-chambered electrolyte storage tank 110 to the redox flow battery system 10. As a further example, the controller 88 may supply H₂ gas from the integrated multi-chambered electrolyte storage tank 110 in response to a pH change, wherein the pH increases beyond a first threshold pH or decreases beyond a second threshold pH. In the case of an IFB, the controller 88 may supply additional H₂ gas to increase a rate of reduction of Fe³⁺ ions and a rate of production of protons, thereby reducing the pH of the positive electrolyte. Furthermore, the pH of the negative electrolyte may be lowered by hydrogen reduction of Fe ions crossing over from the positive electrolyte to the negative electrolyte or by protons, generated at the positive side, crossing over to the negative electrolyte due to a proton concentration gradient and electrophoretic forces. In this manner, the pH of the negative electrolyte may be maintained within a stable region, while reducing the risk of precipitation of Fe³⁺ ions (crossing over from the positive electrode compartment 22) as Fe(OH)₃.

Other control schemes for controlling a supply rate of H₂ gas from the integrated multi-chambered electrolyte storage tank 110 responsive to a change in an electrolyte pH or to a change in an electrolyte SOC, detected by other sensors such as an oxygen-reduction potential (ORP) meter or an optical sensor, may be implemented. Further still, the change in pH or SOC triggering action of the controller 88 may be based on a rate of change or a change measured over a time period. The time period for the rate of change may be predetermined or adjusted based on time constants for the redox flow battery system 10. For example, the time period may be reduced if a recirculation rate is high, and local changes in concentration (e.g., due to side reactions or gas leaks) may quickly be measured since the time constants may be small.

The controller 88 may further execute control schemes based on an operating mode of the redox flow battery system 10. For example, the controller 88 may control charging and discharging of the redox flow battery cell 18 so as to cause iron preformation at the negative electrode 26 during system conditioning (where system conditioning may include an operating mode employed to optimize electrochemical performance of the redox flow battery system 10 outside of battery cycling). That is, during system conditioning, the controller 88 may adjust one or more operating conditions of the redox flow battery system 10 to plate iron metal on the negative electrode 26 to improve a battery charge capacity during subsequent battery cycling (thus, the iron metal may be preformed for battery cycling). The controller 88 may further execute electrolyte rebalancing as discussed above to rid the redox flow battery system 10 of excess hydrogen gas and reduce Fe³⁺ ion concentration. In this way, preforming iron at the negative electrode 26 and running electrolyte rebalancing during the system conditioning may increase an overall capacity of the redox flow battery cell 18 during battery cycling by mitigating iron plating loss. As used herein, battery cycling (also referred to as “charge cycling”) may include alternating between a charging mode and a discharging mode of the redox flow battery system 10.

It will be appreciated that all components apart from the sensors 60 and 62 and the integrated multi-chambered electrolyte storage tank 110 (and components included therein) may be considered as being included in a power module 120. As such, the redox flow battery system 10 may be described as including the power module 120 fluidly coupled to the integrated multi-chambered electrolyte storage tank 110 and communicably coupled to the sensors 60 and 62. In some examples, each of the power module 120 and the multi-chambered electrolyte storage tank 110 may be included in a single housing (not shown), such that the redox flow battery system 10 may be contained as a single unit in a single location. It will further be appreciated the positive electrolyte, the negative electrolyte, the sensors 60 and 62, the electrolyte rebalancing reactors 80 and 82, and the integrated multi-chambered electrolyte storage tank 110 (and components included therein) may be considered as being included in an electrolyte subsystem 130. As such, the electrolyte subsystem 130 may supply one or more electrolytes to the redox flow battery cell 18 (and components included therein).

Referring now to FIG. 2, it illustrates a side view of an example redox flow battery system layout 200 for the redox flow battery system 10. Redox flow battery system layout 200 may be housed within a housing 202 that facilitates long-distance transport and delivery of the redox flow battery system 10. In some examples, the housing 202 can include a standard steel freight container or a freight trailer that can be transported via rail, truck or ship. The redox flow battery system layout 200 can include the integrated multi-chambered electrolyte storage tank 110. As an example of conventional external rebalancing reactors, one or more rebalancing reactors (e.g., rebalancing reactor 80) may be positioned external to redox flow battery cell stacks 214 and at a first side of the housing 202, and a power module 210, and power control system (PCS) 288 at a second side of the housing 202. Electrolyte travels a distance from the first side to the second side of housing 202 to flow from power module 210 to rebalancing reactor 80. During this time, many small hydrogen gas bubbles entrained within the electrolyte may coalesce into fewer larger hydrogen gas bubbles.

Auxiliary components such as supports 206, as well as various piping 204, pumps 230, valves (not shown at FIG. 2), and the like may be included within the housing 202 (as further described above with reference to FIG. 1) for stabilizing and fluidly connecting the various components positioned therein. For example, one or more pumps 230 may be utilized to convey electrolyte from the integrated multi-chambered electrolyte storage tank 110 to one or more redox flow battery cell stacks 214 within the power module 210. Furthermore, additional pumps 230 may be utilized to return electrolyte from the power module 210 to the negative electrolyte chamber 50 or the positive electrolyte chamber 52 of the integrated multi-chambered electrolyte storage tank 110.

Power module 210 may include one or more redox flow battery cell stacks 214 electrically connected in parallel and/or in series. Each of the one or more redox flow battery cell stacks 214 may further include a plurality of redox flow battery cells, such as the redox flow battery cell 18 of FIG. 1, connected in parallel and/or series. In this way, power module 210 may be able to supply a range of current and/or voltages to external loads. The PCS 288 includes controller 88 of FIG. 1, as well as other electronics, for controlling and monitoring operation of the redox flow battery system 10. Furthermore, PCS 288 may regulate and monitor voltage supplied to external loads, as well as supplying current and/or voltage from external sources for charging of the power module 210. The PCS 288 may further regulate and control operation of the redox flow battery system 10 during an idle state or idle mode. The redox flow battery system 10 may be in an idle state when the power module 210 is not in a charge mode or a discharge mode. As an example, the power module 210 may be in the charge mode when an external voltage or current is supplied to one or more redox flow battery cells 18 of the power module 210 resulting in reduction of electrolyte and plating of the reduced electrolyte at the bipolar plate 36 connected to the negative electrode(s) of the one or more redox flow battery cells 18. For the case of an IFB, ferrous ions may be reduced at the plating electrode(s) of one or more redox flow battery cells 18, thereby plating iron thereat during charging of the power module 210. As another example, the power module 210 may be in the discharge mode when voltage or current is supplied from one or more redox flow battery cells 18 of the power module 210 resulting in oxidation of plated metal at the negative electrode resulting in deplating (e.g., loss of metal) and solubilizing of the oxidized metal ions. For the case of an IFB, iron may be oxidized at the plating electrode of one or more redox flow battery cells 18, thereby solubilizing ferrous ions thereat during discharging of the power module 210.

As another example, PCS 288 may control a charging/discharging current and voltage of each redox flow battery cell stack 214 of the power module 210. Charging and discharging current may be adjusted by PCS 288 according to a power demand input to PCS 288 by a user of the power module 210. PCS 288 may control discharging of each redox flow battery cell stack 214 such that an underperforming redox flow battery stack may be discharged less than a high performing redox flow battery stack.

As described above, some issues may result due to an external rebalancing reactor (e.g., rebalancing reactor 80) being spaced away from one or more redox flow battery cell stacks (e.g., one or more redox flow battery cell stacks 214). The spacing may allow for hydrogen gas entrained within the electrolyte to coalesce into large hydrogen gas bubbles and thereby reduce a rate of a rebalancing reaction and demand additional components to break up the large hydrogen gas bubbles. Such additional components add to a parasitic power draw of a redox flow battery system. Further, the external rebalancing reactor, when formed as a catalyst jelly roll may receive electrolyte and hydrogen gas at a radial center of the catalyst jelly roll and flow of the electrolyte outward may be limited, reducing an effective amount of catalyst interacting with the electrolyte. Positioning an internal rebalancing reactor within a negative electrolyte outlet may allow reaction of the negative electrolyte before hydrogen bubbles have time to coalesce. Additionally, electrolyte may be directed towards an outer surface of the internal rebalancing reactor and forced radially inward thereby increasing an effective amount of catalyst interacting with the electrolyte.

Turning now to FIG. 3, an example of a perspective view of a battery stack 300, such as one of the one or more redox flow battery cell stacks 214 of FIG. 2, is shown. A set of reference axis 301 is provided, indicating a y-axis, an x-axis, and a z-axis. The battery stack 300 comprises a series of interior components arranged as layers within the battery stack 300. The layers may be positioned co-planar with a y-x plane and stacked along the z-axis.

A first pressure plate 302a may be arranged at a first end 303 and a second pressure plate 302b may be arranged at a second end 305 of the battery stack 300. Together first pressure plate 302a and second pressure plate 302b may be referred to a pressure plates 302. Pressure plates 302 may provide rigid end walls that define boundaries of the battery stack 300. The pressure plates 302 allow interior components of the battery stack 300 to be pressed together between the pressure plates 302 to seal components of the battery stack within an interior 307 of battery stack 300. Picture frames may be arranged inside of the pressure plates 302, e.g., against sides of the pressure plates 302 facing inwards along the z-axis, towards the interior of the battery stack 300, the picture frames may be adapted to interface with one another to seal fluids within the interior 307 of the battery stack 300. The fluids sealed within the interior 307 may be positive or negative electrolyte. Interior 307 may further comprise interior components which may include at least a plurality of negative spacers, negative electrodes, bipolar plates, positive electrodes, and membranes. Each of the negative spacers, negative electrodes, bipolar plates, positive electrodes, and membranes may be arranged in a sequence to form one of a plurality of redox flow battery cells (similar to redox flow battery cell 18 of FIG. 1) comprising battery stack 300. Electrolyte contacting the interior components of battery stack 300 may participate in reactions associated with charging and discharging of the redox flow battery system as described above with respect to FIG. 1.

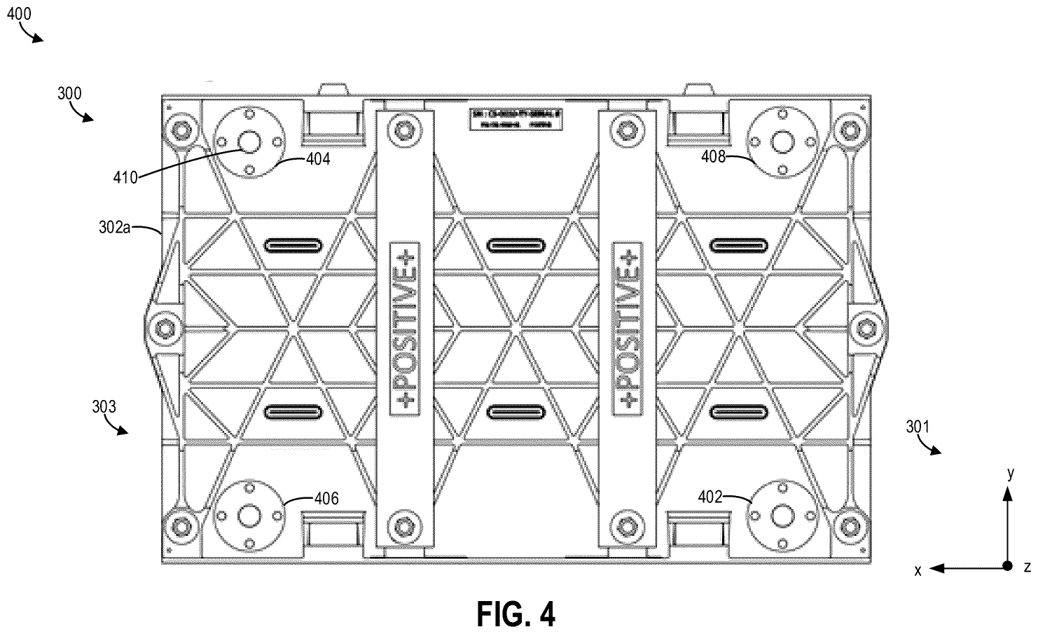

FIG. 4 shows a front view 400 of battery stack 300 looking at first end 303. Battery stack 300 may further include a first negative inlet flange 402, a first negative outlet flange 404, a first positive inlet flange 406, and a first positive outlet flange 408 protruding from first pressure plate 302a. In one example, first negative outlet flange 404 may be positioned opposite first positive inlet flange 406 along the y-axis and opposite first positive outlet flange 408 along the x-axis. In the same example, first negative inlet flange 402 may be positioned opposite of first positive inlet flange 406 across the x-axis and opposite of first positive outlet flange 408 across the y-axis. A second negative inlet flange, second negative outlet flange, second positive inlet flange, and second positive outlet flange may also protrude from second pressure plate 302b positioned at second end 305 of battery stack 300 as shown in FIG. 3. In one example, second pressure plate 302b positioned at second end 305 of battery stack 300 may be configured opposite across the z-axis of first pressure plate 302a positioned at first end 303. For example, when looking at first end 303 along the z-axis, negative outlet flange 404 may be positioned at an upper left corner of first pressure plate 302a and when looking at second end 305 along the z-axis from the opposite direction, negative outlet flange 404 may be positioned in an upper right corner of second pressure plate 302b.

First negative inlet flange 402 and the second negative inlet flange may be configured to receive negative electrolyte and may be fluidly coupled to a negative electrolyte flow path within battery stack 300. The negative electrolyte path may be configured to flow through at least the plurality of negative spacers, negative electrodes, bipolar plates and membranes. The negative electrolyte flow path may also be fluidly coupled to first negative outlet flange 404 and the second negative outlet flange. In one example, during operation of a redox flow battery system including battery stack 300, negative electrolyte may enter battery stack 300 through first negative inlet flange 402 positioned at first end 303, interact with the plurality of negative electrodes, bipolar plates and membranes and exit battery stack 300 through the second negative outlet flange positioned at second end 305. First positive inlet flange 406 and the second positive inlet flange may be configured to receive positive electrolyte and may be fluidly coupled to a positive electrolyte flow path within battery stack 300. The positive electrolyte flow path may be fluidly coupled to at least the plurality of positive electrodes, bipolar plates, and membranes. The positive electrolyte path may be fluidly coupled to first positive outlet flange 408 and the second positive outlet flange. Similarly, positive electrolyte may enter battery stack 300 through first positive inlet flange 406 and the second positive inlet flange, interact with the plurality of positive electrodes, bipolar plates and membranes, and exit battery stack 300 through the second positive outlet flanged positioned at second end 305. As described above with respect to FIG. 2, battery stack 300 may be arranged in series or in parallel with other battery stacks. Accordingly, battery stack 300 may be fluidly coupled via first negative outlet flange 404, first negative inlet flange 402, first positive inlet flange 406, and/or first positive outlet flange 408 to a neighboring battery stack, an electrolyte chamber, and/or an external rebalancing reactor spaced away from battery stack 300.

First negative outlet flange 404 may include an opening 410. Opening 410 may circumferentially surround an internal rebalancing reactor such as internal rebalancing reactor 502 shown in FIGS. 5A and 5B. View 500 of FIG. 5A shows internal rebalancing reactor 502 in a first state before winding. Internal rebalancing reactor 502 may include a backing layer 504 and a catalyst layer 506. Backing layer 504 may be formed of a flexible material through which electrolyte may permeate and which may withstand degradation upon prolonged exposure to positive and/or negative electrolytes in the presence of dissolved hydrogen gas. In one example, backing layer 504 may be a coarse plastic mesh. Backing layer 504 may provide physical support to catalyst layer 506. Catalyst layer 506 may be formed of a conductive material in which a metal catalyst may be impregnated or otherwise immobilized. Further, the metal catalyst may be homogenously distributed throughout the conductive material. For example, catalyst layer 506 may be platinum-on-carbon cloth, wherein platinum (Pt) acts as the catalyst, increasing a rate of the rebalancing reaction shown in equation (4) between Fe³⁺ and hydrogen gas to reduce Fe³⁺ to Fe²⁺. In other examples, the metal catalyst of catalyst layer 506 may be ruthenium (Ru), rhodium (Ru), iron (Fe), titanium (Ti), or combinations thereof. In some examples, metal catalyst comprising internal components of a battery stack, such as battery stack 300, may be present in small quantities. The small quantities may be small enough that a contact between Fe³⁺, hydrogen gas, and the catalyst may be minimal and have substantially no effect on a concentration of Fe³⁺ in the electrolyte.

Dimensions of catalyst layer 506 and backing layer 504 may be chosen such that a length along the z-axis and width along the x-axis of backing layer 504 are larger than a length along the z-axis and width along the y-axis of catalyst layer 506, respectively. In this way, edges of backing layer 504 may extend past edges of catalyst layer 506 when catalyst layer 506 is laid in face sharing contact with backing layer 504 and centered on backing layer 504 with respect to a x-z plane as shown in view 500. As one example backing layer 504 may be substantially 5% longer and 5% wider than catalyst layer 506. As used herein, substantially is equivalent to a range of +/−5%. Further a thickness of catalyst layer 506 and amount of metal catalyst incorporated into catalyst layer 506 may be chosen according to an anticipated throughput of internal rebalancing reactor 502. Said another way, the thickness of catalyst layer 506 and amount of metal catalyst may be chosen based on amount of Fe³⁺ that internal rebalancing reactor 502 is expected to convert to Fe²⁺.

As one example, catalyst layer 506 may be placed in face sharing contact with backing layer 504 as shown in FIG. 5A and wound into a spiral form in a jelly-roll configuration as shown in view 550 of FIG. 5B. In such an example, catalyst layer 506 is not fixedly coupled to backing layer 504 and an adhesive layer between catalyst layer 506 and backing layer 504 is not present. However, other geometries of internal rebalancing reactor 502 have been considered within a scope of this disclosure. Other geometries may include a catalyst layer immobilized on an inert support, but may be formed as beads, powders, as well as other forms not named here. View 550 shows internal rebalancing reactor 502 in spiral form after winding. A length 558 of internal rebalancing reactor 502 may be substantially equal to a length of a battery stack (e.g., distance between first end 303 and second end 305 along the z-axis of battery stack 300 in FIG. 3). In some examples, the length 558 may be greater than the length of the battery stack.

Turning now to FIGS. 6A and 6B, a front view 600 of first negative outlet flange 404 (shown in FIGS. 3-4) and rear view 650 of a second negative outlet flange 424 of battery stack 300 are shown. A diameter of internal rebalancing reactor 502 along the x-axis may be smaller than an internal diameter of first negative outlet flange 404. Internal rebalancing reactor 502 may be inserted length wise (e.g., along the z-axis) through first negative outlet flange 404 (e.g., through an opening such as opening 410 of FIG. 4). In this way, internal rebalancing reactor 502 may be circumferentially surrounded by first negative outlet flange 404 and by interior components comprising an interior (e.g., interior 307 shown in FIG. 3) of the battery stack. As described above with respect to FIG. 4, first negative outlet flange 404 may be fluidly coupled to a negative electrolyte path of battery stack 300 thereby placing internal rebalancing reactor 502 in fluid contact with negative electrolyte. The negative electrolyte path may flow through the interior, the internal components comprising the interior forming a plurality of redox flow battery cells (e.g. redox flow battery cell 18 of FIG. 1). A portion of internal rebalancing reactor 502 may be in face sharing contact with the negative electrolyte path of battery stack 300. A plastic weld 608 may be formed between a lateral outer surface of internal rebalancing reactor 502 and a lateral internal surface of negative outlet flange 404. Plastic weld 608 may prevent gasses from exiting battery stack 300 without passing through at least a portion of internal rebalancing reactor 502.

Turning now to FIG. 6B, rear view 650 shows second negative outlet flange 424 which protrudes from second pressure plate 302b at a second end 305 of battery stack 300, as described with reference to FIG. 3 above. Weld 608 may be positioned between a lateral outer surface of internal rebalancing reactor 502 and a lateral inner surface of second negative outlet flange 424. Second negative outlet flange 424 may be positioned on second pressure plate 302b opposite from first negative outlet flange 404 along the z-axis. In this way, internal rebalancing reactor 502 may be inserted into battery stack 300 through first negative outlet flange 404 and extend through interior 307 of battery stack 300 and into second negative outlet flange 424. In this way, internal rebalancing reactor 502 is not spaced away from battery stack 300 and a distance of travel for electrolyte from the interior components of battery stack 300 to internal rebalancing reactor 502 may be reduced.

Additionally or alternatively, internal rebalancing reactor 502 may positioned at least partially external to a battery stack and directly coupled to a first negative outlet flange and/or a second negative outlet flange, as shown in FIG. 10. For example, an axial end 570 (e.g., along the z-axis) of internal rebalancing reactor 502 may be in face sharing contact with the first negative outlet flange 404. In this way, internal rebalancing reactor 502 may be external to battery stack 300 but not spaced away from battery stack 300 and the distance of travel for electrolyte to internal rebalancing reactor 502 is reduced. Reducing the travel distance minimizes an opportunity for hydrogen gas dissolved in the electrolyte to coalesce into large hydrogen gas bubbles. Smaller hydrogen bubbles may maintain a fast rate of reaction between the hydrogen gas and electrolyte at a surface of catalyst layer 506 without demanding additional powered equipment to disrupt large hydrogen gas bubbles. In other examples, axial end 570 may be in face sharing contact with the second negative outlet flange on pressure plate 302b with substantially the same effect on rate of reaction. In yet other examples, internal rebalancing reactor 502 may be positioned both internally as described above (e.g., through first negative outlet flange 404, interior 307, and second negative outlet flange) and externally such that axial end 570 may extend beyond second pressure plate 302b and/or second axial end 572 may extend beyond first pressure plate 302a.

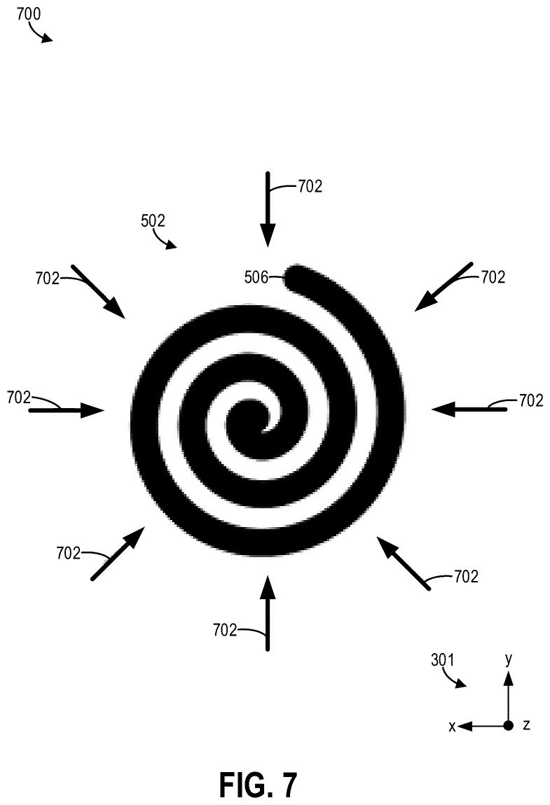

Turning now to FIG. 7, an illustration 700 of an inner cross section of internal rebalancing reactor 502 is shown. The inner cross section is in the y-x plane, showing the spiral winding of catalyst layer 506. Backing layer 504 is not shown in illustration 700 for clarity. When internal rebalancing reactor 502 is positioned internal to a battery stack (such as battery stack 300 as shown in FIGS. 3, 4, and 10), and positive and negative electrolyte are passed through the battery stack (e.g., during a charging, discharging, or idle mode of the redox flow battery system) electrolyte may flow through internal rebalancing reactor 502 following arrows 702. In one example, internal rebalancing reactor 502 may be positioned within a negative outlet flange of the battery stack, as shown in FIGS. 6A-B and the electrolyte may be negative electrolyte. Additionally or alternatively, internal rebalancing reactor 502 may be positioned within a positive outlet flange (e.g., positive outlet flange 408 of FIG. 4) and the electrolyte may be positive electrolyte. A path of electrolyte into and out of battery stack 300 may be along the z-axis, orthogonal to arrows 702. Electrolyte traveling through an electrolyte outlet of the battery stack may be forced to pass through at least an outer layer of catalyst layer 506 following a direction indicated by arrows 702, before exiting the battery stack. In this way, an area of catalyst layer 506 exposed to the electrolyte is increased compared to an example where electrolyte is introduced to and flowed through a radial center of a spirally wound catalyst roll along the z-axis outward.

A battery stack including an internal rebalancing reactor (such as internal rebalancing reactor 502 shown in FIG. 5A-B) positioned within a negative outlet flange as shown in FIGS. 6A-B may be compared to the same battery stack including a negative outlet flange fluidly coupled to an external rebalancing reactor (e.g., as shown in FIG. 2). FIGS. 8A-C show graphs of battery stack efficiency as a function of number of cycles where one cycle is equivalent to completely charging and discharging a redox flow battery system including the battery stack one time. Voltage efficiency is shown in graph 800 of FIG. 8A, coulombic efficiency is shown in graph 830 of FIG. 8B and energy efficiency is shown in graph 860 of FIG. 8C. An arrow 804 of FIG. 8A, an arrow 834 of FIG. 8B, and an arrow 864 of FIG. 8C each correspond to a direction of increasing efficiency. Efficiencies were measured for over a threshold number of cycles for a battery stack fluidly coupled to the external rebalancing reactor. For example, the threshold number of cycles may be 100 cycles. Afterwards, the external rebalancing reactor was decoupled from the battery stack and an internal rebalancing reactor was positioned internal to the battery stack and circumferentially surrounded by a negative electrolyte outlet flange. An arrow 806 of FIG. 8A, an arrow 836 of FIG. 8B, and an arrow 866 of FIG. 8C each correspond to a direction of increasing number of cycles. A line 802 of graph 800, a line 832 of graph 830, and a line 862 of graph 860 may each denote a cycle at which the external rebalancing reactor was swapped for the internal rebalancing reactor. Graphs 800, 830, and 860 show that efficiencies of the battery stack are the same or increased after replacing the external rebalancing reactor with the internal rebalancing reactor.

Turning now to FIG. 9, a flowchart of an example of a method 900 of operating a redox flow battery system including an internal rebalancing reactor is shown. The redox flow battery may be similar to redox flow battery system 10 of FIG. 1 and the internal rebalancing reactor may be similar to internal rebalancing reactor 502 described above with respect to FIGS. 5A-7. The internal rebalancing reactor 502 may be positioned internal to a battery stack, such as battery stack 300 of FIG. Method 900 may be carried out via the controller 88 of FIG. 1, and may be stored as executable instructions at a non-transitory storage medium (e.g., memory) communicably coupled to controller 88. Method 900 may be executed upon activation of the redox flow battery system. For example, electrolyte flow may be driven and controlled by one or more pumps and valves and the battery system may be operating in a charging, discharging, or idling mode.

At 902, method 900 includes flowing positive and negative electrolyte from respective electrolyte storage tanks to respective battery stack inlets. In one example, positive electrolyte may be stored in a first chamber of a multi-chambered electrolyte storage tank and negative electrolyte may be stored in a second chamber of a multi-chambered electrolyte storage. The multi-chambered electrolyte storage tank may be similar to multi-chambered electrolyte storage tank 110 of FIG. 1. Further, the battery stack inlets may be the positive inlet flange and negative inlet flange protruding from a first and or second pressure plate of the battery stack as described above with respect to FIG. 4.

At 904, method 900 includes flowing positive and negative electrolyte through respective internal components of the battery stack. Positive electrolyte may flow through a positive electrolyte path and negative electrolyte may flow through a negative electrolyte path as described above with respect to FIG. 4. While flowing through internal components of the battery stack, chemical reactions may occur according to an operating mode of the redox flow battery system as described above with respect to FIG. 1. Additionally, undesirable side reactions may occur and/or electrolyte crossover may occur, resulting in an unwanted presence of Fe³⁺ species in the negative electrolyte as well as evolving hydrogen gas.

At 906, method 900 includes contacting the negative electrolyte with the internal rebalancing reactor. The internal rebalancing reactor may be positioned within the negative electrolyte outlet passage as described above with respect to FIGS. 6A-6B. The internal rebalancing reactor may include a metallic catalyst such as platinum on a conductive substrate such as carbon. When Fe³⁺ in the negative electrolyte contacts hydrogen gas at a surface of the catalyst, reaction of the Fe³⁺ with the hydrogen gas to reduce Fe³⁺ to Fe²⁺ may occur. The hydrogen gas may be distributed as many small bubbles within the negative electrolyte, thereby providing increased surface area for the rebalancing reaction to occur. In this way, rebalancing of the negative electrolyte may occur within the battery stack and before subsequent step (step 908) of method 900 occurs.

At 908, method 900 includes flowing positive and negative electrolyte through their respective outlets (e.g., positive outlet flange 408 and negative outlet flange 404 of FIG. 4). Any Fe³⁺ present in the negative electrolyte may be at least partially reduced to Fe²⁺ at step 908. At 910, method 900 includes flowing the positive and negative electrolytes the negative out of the battery stack to return to their respective electrolyte chambers. Method 900 returns.

The technical effect of method 900 is to contact negative electrolyte with an electroactive catalyst before the negative electrolyte flows out of the battery stack. Hydrogen bubbles which have formed in the negative electrolyte remain small and dispersed, providing increased opportunities for the rebalancing reaction to occur at the catalyst. In this way, fewer large hydrogen gas bubbles within the negative electrolyte may be avoided and an injector and booster pump for breaking up the large hydrogen gas bubbles may not be demanded. Without the booster pump and injector, a parasitic power draw of the rebalancing reactor may be decreased without decreasing an overall efficiency of the redox flow battery system.

The disclosure also provides support for a redox flow battery system, comprising: a positive electrolyte and a negative electrolyte a battery stack configured to receive the positive and negative electrolytes and including an internal rebalancing reactor positioned internal to the battery stack and in fluid contact with the negative electrolyte. In a first example of the system, the internal rebalancing reactor includes a catalyst layer and a backing layer supports the catalyst layer. In a second example of the system, optionally including the first example, the catalyst layer and backing layer are wound in a spiral. In a third example of the system, optionally including one or both of the first and second examples, the catalyst layer includes a metal catalyst and a conductive material. In a fourth example of the system, optionally including one or more or each of the first through third examples, the metal is platinum (Pt), ruthenium (Ru), rhodium (Ru), iron (Fe), titanium (Ti), or combinations thereof. In a fifth example of the system, optionally including one or more or each of the first through fourth examples, the internal rebalancing reactor is positioned internal to a negative outlet of the battery stack. In a sixth example of the system, optionally including one or more or each of the first through fifth examples, the internal rebalancing reactor does not include a booster pump or an injector.

The disclosure also provides support for a method of operating a redox flow battery system, comprising: flowing negative electrolyte from an electrolyte storage tank through a negative inlet flange of a battery stack, flowing the negative electrolyte through the battery stack and contacting internal components of the battery stack, contacting the negative electrolyte with an internal rebalancing reactor, and flowing the negative electrolyte through a negative outlet flange of the battery stack. In a first example of the method, the negative electrolyte contacting internal components of the battery stack participates in reactions associated with charging and discharging the redox flow battery system. In a second example of the method, optionally including the first example, the internal rebalancing reactor includes a catalyst. In a third example of the method, optionally including one or both of the first and second examples, contacting the negative electrolyte with the internal rebalancing reactor includes reacting Fe³⁺ of the negative electrolyte with hydrogen gas bubbles of the negative electrolyte at a surface of the catalyst. In a fourth example of the method, optionally including one or more or each of the first through third examples, the hydrogen gas bubbles are not coalesced. In a fifth example of the method, optionally including one or more or each of the first through fourth examples the internal rebalancing reactor is positioned internal to the battery stack. In a sixth example of the method, optionally including one or more or each of the first through fifth examples, the method further comprises: flowing the negative electrolyte from the battery stack to the electrolyte storage tank.

The disclosure also provides support for a battery stack, comprising: a plurality of redox flow battery cells, a first pressure plate positioned at a first end of the battery stack and a second pressure plate positioned at a second end of the battery stack, the plurality of redox flow battery cells positioned between the plurality of redox flow battery cells, a first negative outlet flange protruding from the first pressure plate and a second negative outlet flange protruding from the second pressure plate, the first negative outlet flange and second negative outlet flange fluidly coupled to the plurality of redox flow battery cells, an internal rebalancing reactor circumferentially including a first end and a second end and circumferentially surrounded at the first end by the first negative outlet flange and circumferentially surround at the second end by the second negative outlet flange and configured to receive negative electrolyte from the plurality of redox flow battery cells. In a first example of the system, the battery stack further comprises a plastic weld positioned between a lateral outer surface the first end of the internal rebalancing reactor and a lateral inner surface of the first negative outlet flange and/or between a lateral outer surface of the second end of the internal rebalancing reactor and a lateral inner surface of the second negative outlet flange. In a second example of the system, optionally including the first example, a length of the internal rebalancing reactor is substantially equal to a length of the battery stack. In a third example of the system, optionally including one or both of the first and second examples, the internal rebalancing reactor is directly fluidly coupled to a negative electrolyte flow path of the plurality of redox flow battery cells. In a fourth example of the system, optionally including one or more or each of the first through third examples, the internal rebalancing reactor includes a catalyst configured to increase a rate of reduction of Fe³⁺ by hydrogen gas. In a fifth example of the system, optionally including one or more or each of the first through fourth examples, the internal rebalancing reactor is configured to receive the negative electrolyte at an outer surface of the internal rebalancing reactor.

In another representation, the disclosure also provides support for a redox flow battery system, comprising: a positive electrolyte and a negative electrolyte a battery stack configured to receive the positive and negative electrolytes and including an internal rebalancing reactor, wherein the internal rebalancing reactor is not spaced away from the battery stack and in fluid contact with the negative electrolyte. In a first example of the system, the internal rebalancing reactor includes a catalyst layer and a backing layer supports the catalyst layer and the catalyst layer includes a metal catalyst and a conductive material. In a second example of the system, optionally including the first example, the internal rebalancing reactor is positioned internal to a negative outlet flange of the battery stack. In a third example of the system, optionally including one or both of the first and second examples, the internal rebalancing reactor is external to the battery stack and an axial end of the internal rebalancing reactor is in face sharing contact with a negative outlet flange of the battery stack.

FIGS. 2-6B and 10 show example configurations with relative positioning of the various components. If shown directly contacting each other, or directly coupled, then such elements may be referred to as directly contacting or directly coupled, respectively, at least in one example. Similarly, elements shown contiguous or adjacent to one another may be contiguous or adjacent to each other, respectively, at least in one example. As an example, components laying in face-sharing contact with each other may be referred to as in face-sharing contact. As another example, elements positioned apart from each other with only a space there-between and no other components may be referred to as such, in at least one example. As yet another example, elements shown above/below one another, at opposite sides to one another, or to the left/right of one another may be referred to as such, relative to one another. Further, as shown in the figures, a topmost element or point of element may be referred to as a “top” of the component and a bottommost element or point of the element may be referred to as a “bottom” of the component, in at least one example. As used herein, top/bottom, upper/lower, above/below, may be relative to a vertical axis of the figures and used to describe positioning of elements of the figures relative to one another. As such, elements shown above other elements are positioned vertically above the other elements, in one example. As yet another example, shapes of the elements depicted within the figures may be referred to as having those shapes (e.g., such as being circular, straight, planar, curved, rounded, chamfered, angled, or the like). Further, elements shown intersecting one another may be referred to as intersecting elements or intersecting one another, in at least one example. Further still, an element shown within another element or shown outside of another element may be referred as such, in one example. FIGS. 2-6B and 10 are drawn approximately to scale, although other dimensions or relative dimensions may be used.

As used herein, the term “approximately” is construed to mean plus or minus five percent of the range unless otherwise specified.

The following claims particularly point out certain combinations and sub-combinations regarded as novel and non-obvious. These claims may refer to “an” element or “a first” element or the equivalent thereof. Such claims should be understood to include incorporation of one or more such elements, neither requiring nor excluding two or more such elements. Other combinations and sub-combinations of the disclosed features, functions, elements, and/or properties may be claimed through amendment of the present claims or through presentation of new claims in this or a related application. Such claims, whether broader, narrower, equal, or different in scope to the original claims, also are regarded as included within the subject matter of the present disclosure.

1. A redox flow battery system, comprising:
a positive electrolyte and a negative electrolyte;
a battery stack configured to receive the positive electrolyte and negative electrolyte and including an internal rebalancing reactor positioned internal to the battery stack and in fluid contact with the negative electrolyte.

2. The redox flow battery system of claim 1, wherein the internal rebalancing reactor includes a catalyst layer, and a backing layer supports the catalyst layer.

3. The redox flow battery system of claim 2, wherein the catalyst layer and backing layer are wound in a spiral.

4. The redox flow battery system of claim 2, wherein the catalyst layer includes a metal catalyst and a conductive material.

5. The redox flow battery system of claim 4, wherein the metal catalyst is platinum (Pt), ruthenium (Ru), rhodium (Ru), iron (Fe), titanium (Ti), or combinations thereof.

6. The redox flow battery system of claim 1, wherein the internal rebalancing reactor is positioned internal to a negative outlet of the battery stack.

7. The redox flow battery system of claim 1, wherein the internal rebalancing reactor does not include a booster pump or an injector.

8. A method of operating a redox flow battery system, comprising:
flowing negative electrolyte from an electrolyte storage tank through a negative inlet flange of a battery stack;
flowing the negative electrolyte through the battery stack and contacting internal components of the battery stack;
contacting the negative electrolyte with an internal rebalancing reactor; and
flowing the negative electrolyte through a negative outlet flange of the battery stack.

9. The method of claim 8, wherein the negative electrolyte contacting internal components of the battery stack participates in reactions associated with charging and discharging the redox flow battery system.

10. The method of claim 8, wherein the internal rebalancing reactor includes a catalyst.

11. The method of claim 10, wherein contacting the negative electrolyte with the internal rebalancing reactor includes reacting Fe³⁺ of the negative electrolyte with hydrogen gas bubbles of the negative electrolyte at a surface of the catalyst.

12. The method of claim 11, wherein the hydrogen gas bubbles are not coalesced.

13. The method of claim 8, wherein the internal rebalancing reactor is positioned internal to the battery stack.

14. The method of claim 8, further comprising flowing the negative electrolyte from the battery stack to the electrolyte storage tank.

15. A battery stack, comprising:
a plurality of redox flow battery cells;
a first pressure plate positioned at a first end of the battery stack and a second pressure plate positioned at a second end of the battery stack, the plurality of redox flow battery cells positioned between the plurality of redox flow battery cells;
a first negative outlet flange protruding from the first pressure plate and a second negative outlet flange protruding from the second pressure plate, the first negative outlet flange and second negative outlet flange fluidly coupled to the plurality of redox flow battery cells;
an internal rebalancing reactor including a first end and a second end and circumferentially surrounded at the first end by the first negative outlet flange and circumferentially surround at the second end by the second negative outlet flange and configured to receive negative electrolyte from the plurality of redox flow battery cells.

16. The battery stack of claim 15, wherein the battery stack further comprises a plastic weld positioned between a lateral outer surface of the first end of the internal rebalancing reactor and a lateral inner surface of the first negative outlet flange and/or between a lateral outer surface of the second end of the internal rebalancing reactor and a lateral inner surface of the second negative outlet flange.

17. The battery stack of claim 15, wherein a length of the internal rebalancing reactor is substantially equal to a length of the battery stack.

18. The battery stack of claim 15, wherein the internal rebalancing reactor is directly fluidly coupled to a negative electrolyte flow path of the plurality of redox flow battery cells.

19. The battery stack of claim 15, wherein the internal rebalancing reactor includes a catalyst configured to increase a rate of reduction of Fe³⁺ by hydrogen gas.

20. The battery stack of claim 15, wherein the internal rebalancing reactor is configured to receive the negative electrolyte at an outer surface of the internal rebalancing reactor.
